(19) United States
(12) Patent Application Publication
(10) Pub. No.: US 2026/0210335 A1
(43) Pub. Date: Jul. 23, 2026

(54) PLANETARY CARRIER WITH LUBRICANT LINES FOR AXIAL SLIDING BEARING SEGMENTS

(71) Applicants: ZF FRIEDRICHSHAFEN AG, Friedrichshafen (DE); ZF Wind Power Antwerpen N.V., Lommel (BE)

(72) Inventor: Michel GOOVAERTS, Hulshout (BE)

(21) Appl. No.: 19/422,507

(22) Filed: Dec. 17, 2025

(30) Foreign Application Priority Data
Dec. 20, 2024 (DE) 10 2024 212 231.9

(51) Int. Cl. F03D 15/10; F03D 80/70; F16H 57/04; F16H 57/08

(52) U.S. Cl. CPC F03D 15/101; F03D 80/70; F16H 57/0479; F16H 57/082; F05B 2260/40311

(57) ABSTRACT

A drive arrangement for a wind turbine includes a planetary carrier and a planetary gear. The planetary gear is rotatably mounted in the planetary carrier. The planetary carrier has at least one lubricant line which opens into a space between the at least one planetary gear and a side plate of the planetary carrier.

### CROSS REFERENCE TO RELATED APPLICATIONS

This application claims benefit to German Patent Application No. DE 10 2024 212 231.9, filed on Dec. 20, 2024, which is hereby incorporated by reference herein.

### FIELD

The disclosure relates to a drive arrangement.

### BACKGROUND

Planetary gearboxes with radially and axially mounted planetary carriers are known from the prior art. For example, US 2012 108 380 A2 discloses such a gearbox. A radial sliding bearing of a planetary gear is supplied with lubricant via bores in a planetary bolt, which are connected to bores in the planetary carrier in a lubricant-conducting manner. The lubricant passes through the radial sliding bearing into the axial sliding bearings.

In the case of helical gearing, the tooth engagement forces cause a tilting of the planetary gear. This is particularly problematic in the case of axial sliding bearings consisting of several segments. In the segments that are most stressed by the inclination, mixed friction can occur, resulting in damage and accelerated wear.

### SUMMARY

In an embodiment, the present disclosure provides a drive arrangement for a wind turbine including a planetary carrier and a planetary gear. The planetary gear is rotatably mounted in the planetary carrier. The planetary carrier has at least one lubricant line which opens into a space between the at least one planetary gear and a side plate of the planetary carrier.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a planetary carrier, in accordance with one or more aspects of the present disclosure; and

FIG. 2 shows a sectional view of the planetary carrier, in accordance with one or more aspects of the present disclosure.

### DETAILED DESCRIPTION

The disclosure provides an improved drive arrangement for a wind turbine compared to the prior art.

The drive arrangement according to aspects of the disclosure comprises a planetary carrier and at least one planetary gear. The planetary carrier can be rotatably mounted. In particular, the planetary carrier can be rotatably mounted in a gear housing and/or in a housing-fixed structure.

The at least one planetary gear, in turn, is rotatably mounted in the planetary carrier. In particular, the planetary gear is rotatable relative to the planetary carrier. A planetary bolt may be provided for the mounting of the planetary gear, which planetary bolt is fixed in one side plate of the planetary carrier and, if needed, in another side plate. In this case, the mounting of the planetary gear in the planetary carrier is carried out by mounting the planetary gear on the planetary bolt. In particular, one or more radial bearings, for example configured as sliding bearings, may be installed on the planetary bolt for the planetary gear. The term side plate refers to a section of the planetary carrier that extends essentially in a radial direction and forms planetary bolts or has receptacles for fixing the bolts.

According to the disclosure, the planetary carrier has at least one lubricant line that opens into an intermediate space between the planet gear and the side plate.

The intermediate space is a free space, i.e. a space that does not contain any components of the wind turbine or the drive assembly. The intermediate space is completely filled with air and/or lubricant. It is delimited in the axial direction by the planetary gear or a front surface of the planetary gear and the side plate.

The at least one lubricant line opens into the intermediate space. This means that an opening of the lubricant line is located in the intermediate space or directly adjacent to the intermediate space. Lubricant conveyed by the at least one lubricant line therefore enters the intermediate space directly via the opening. This can improve the lubricant supply to an axial bearing with which the planetary gear is rotatably mounted in the planetary carrier.

The at least one lubricant line can advantageously be implemented by means of at least one through bore hole In a corresponding preferred further embodiment, the side plate has at least one through bore hole. This runs through the side plate and has two openings accordingly.

The at least one through bore hole preferably runs axially, i.e., parallel to a center axis and/or axis of rotation of the planetary carrier. Specifically, a center axis of the at least one through bore hole is aligned parallel to the center axis and/or axis of rotation.

According to a further embodiment, the at least one through bore hole opens into the intermediate space. Accordingly, one of the two openings is located in the intermediate space or directly adjacent to the intermediate space.

In an alternative preferred further embodiment, the at least one through bore hole does not open directly into the intermediate space, but via a nozzle which is installed in one of the openings of the through bore hole. This allows lubricant which is conducted by the at least one through bore hole to be introduced into the intermediate space via the nozzle.

The further implementation of the at least one lubricant line by means of at least one through bore hole is advantageous in terms of manufacturing. A through bore hole can be introduced into the side plate in a single manufacturing step, which is particularly time-saving and cost-effective.

In the circumferential direction, i.e., along circular arcs whose center lies on the center and/or axis of rotation of the planetary carrier and which are aligned orthogonally to the center and/or axis of rotation, the intermediate space extends in a preferred further embodiment between one or two sliding bearing segments which form an axial bearing for the planetary gear and are fixed in the side plate. In the circumferential direction, the intermediate space is thus delimited by the one or two sliding bearing segments.

In the case of a segment, the sliding segment alone, i.e., without any further sliding segments, forms the axial bearing. In the circumferential direction, it is not closed in itself, but is interrupted and thus has a gap. In this gap, the aforementioned intermediate space extends.

In the case of two sliding bearing segments, these are spaced apart from each other so that two gaps open up in the circumferential direction between the two sliding bearing segments. These gaps each form an intermediate space of the type described above.

Due to the configuration of the axial bearing according to the further embodiment, a rotation of the planetary gear causes lubricant to be conveyed from the intermediate space into a bearing gap running between the planetary gear and the respective sliding bearing segment. This counteracts insufficient lubrication in a particularly reliable manner.

In a further preferred embodiment, the drive arrangement has a lubricant transfer ring. This ring is rotationally symmetrical and arranged coaxially with the planetary carrier. An axis of symmetry of the lubricant transfer ring therefore coincides with the center and/or axis of rotation of the planetary carrier.

The lubricant transfer ring is fixed on the side plate. It is configured to engage in a housing-fixed groove. The groove can be formed by the gear housing or a housing-fixed structure.

When the lubricant transfer ring engages in the groove, it forms a cavity together with the groove. The cavity serves to conduct lubricant. It is connected to the at least one lubricant line in a lubricant-conducting manner. For example, the lubricant transfer ring may have at least one through bore hole whose opening is directly adjacent to an opening of the at least one lubricant line.

Since the groove is a housing-fixed groove, it can be connected to a housing-fixed pump in a lubricant-conducting manner using rigid lines. In this way, a lubricant-conducting connection between the pump and the at least one intermediate space mentioned above is established via the cavity and the at least one lubricant line.

Preferred exemplary embodiments of the disclosure are shown in the figures. Corresponding reference numerals denote identical or functionally identical features.

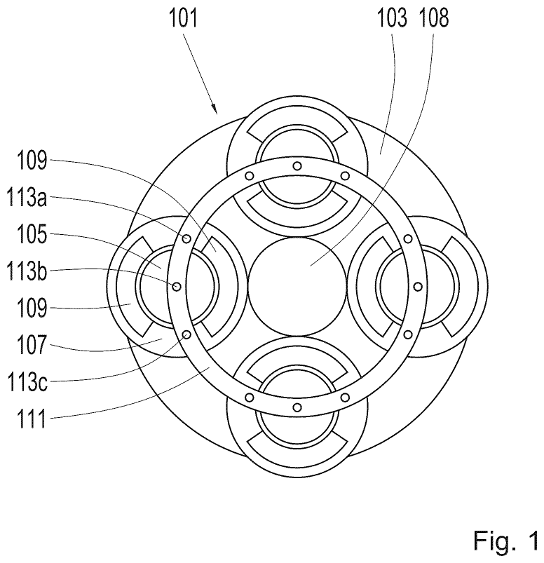

The planetary carrier 101 shown in FIG. 1 has one or two side plates 103. Several planetary bolts 105 are fixed in the side plates 103 by force-fit and form-fit. The planetary bolts 105 serve the mounting of one planetary gear 107 each. The planetary gears 107 mesh with a sun gear 108 and a ring gear not shown in FIG. 1. If there are two side plates 103, the planetary gears 107 are located between the side plates 103.

In the side plates 103, the planetary gears 107 are supported by an axial bearing, which is formed by two circular ring-shaped sliding bearing segments 109. The sliding bearing segments 109 are fixed in the respective side plate 103 and have a circular ring segment-shaped basic form. The basic form of each sliding bearing segment 109 thus corresponds to a segment of a circular ring.

A lubricant transfer ring 111 is provided for the lubricant supply. The lubricant transfer ring 111 is fixed in the side plate 103 on an axial side of the side plate 103 opposite the sliding bearing segments 109. In order to direct lubricant from the lubricant transfer ring 111 towards the sliding bearing segments 109, the lubricant transfer ring 111 has three through bore holes for each planetary gear 109 [sic 107]—a first bore 113a, a second bore 113b and a third bore 113c. The three bores 113a, 113b, 113c each open into a through bore hole in the side plate 103. The side plate 103 thus has a first bore into which the first bore 113a of the lubricant transfer ring 111 opens, a second bore into which the second bore 113b of the lubricant transfer ring 111 opens, and a third bore into which the third bore 113c of the lubricant transfer ring 111 opens.

The second bore of the side plate 103 is connected via a lubricant line in the planetary bolt 105 to a radial sliding bearing of the planetary gear 107 in a lubricant-conducting manner. The first bore and the second bore of the side plate 103 each open into one of two intermediate spaces extending between the sliding bearing segments 109 of a planetary gear 107. Lubricant that enters the intermediate spaces in this way serves to lubricate the sliding bearing segments 109.

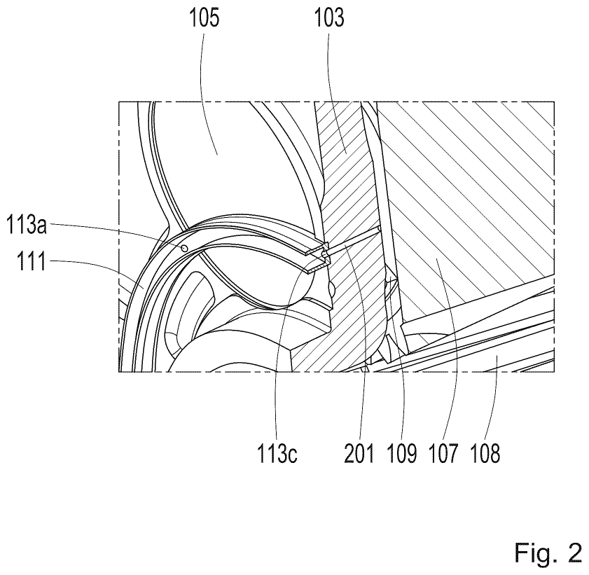

The sectional view in FIG. 2 also shows the course of the bores in the side plate 103. The third bore 201 is shown here exemplarily. Like the other bores in the side plate 103, the third bore 201 is configured as a straight, axially aligned through bore hole.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

101 planetary carrier
103 side plate
105 planetary bolt
107 planetary gear
108 sun gear
109 sliding bearing segment
111 lubricant transfer ring
113a bore
113b bore
113c bore
201 bore

1. A drive arrangement for a wind turbine, comprising:
a planetary carrier; and
at least one planetary gear that is rotatably mounted in the planetary carrier,
wherein the planetary carrier has at least one lubricant line which opens into an intermediate space between the at least one planetary gear and a side plate of the planetary carrier.

2. The drive arrangement according to claim 1; wherein
the side plate has at least one through bore hole that opens into the intermediate space.

3. The drive arrangement according to claim 1, wherein
the side plate has at least one through bore hole with a nozzle, and wherein the nozzle is mounted in an opening of the through bore hole and opens into the intermediate space.

4. The drive arrangement according to claim 1, wherein
the intermediate space is delimited in a circumferential direction by one or two sliding bearing segments fixed in the side plate, which form an axial bearing for the at least one planetary gear.

5. The drive arrangement according to claim 1,further comprising:
a rotationally symmetrical lubricant transfer ring which is arranged coaxially to the planetary carrier and is fixed to the side plate, and which is configured to engage in a housing-fixed groove and to form a cavity with the housing-fixed groove, wherein the cavity is connected to the at least one lubricant line in a lubricant-conducting manner.
